(19) United States
(12) Patent Application Publication
(10) Pub. No.: US 2010/0229568 A1
(43) Pub. Date: Sep. 16, 2010

(54) GAS TURBINE ENGINE

(76) Inventor: Kevork Nercessian, Seefeld (DE)

Correspondence Address: QUARLES & BRADY LLP, 411 E. WISCONSIN AVENUE, SUITE 2040, MILWAUKEE, WI, 53202-4497, US

(21) Appl. No.: 12/468,918

(22) Filed: May 20, 2009

Related U.S. Application Data
(63) Continuation-in-part of application No. 12/265,591, filed on Nov. 5, 2008.
Application No. 12/265,591 is a continuation-in-part of application No. 12/124,828, filed on May 21, 2008, now abandoned.

(30) Foreign Application Priority Data
Aug. 2, 2007 (EP) 07015217.8

(51) Int. Cl. F02C 3/10; F01D 17/00

(52) U.S. Cl. 60/792; 415/145

(57) ABSTRACT

A gas turbine engine is disclosed having a compressor, a combustion chamber downstream of the compressor, and a turbine downstream of the combustion chamber. The compressor includes a first group of compressor blade wheels and a second group of compressor blade wheels downstream of the first group of compressor blade wheels and rotating in an opposite direction such that a deviation of a performance, defined as air mass flow per second between the first group of compressor blade wheels and the second group of compressor blade wheels, is minimized, and a detachment of the air mass flow from blades of a first blade wheel of the second group of compressor blade wheels is substantially eliminated. A bypass enables the air mass flow flowing from the first group of the compressor blade wheels to substantially serve all of the second group of compressor blade wheels substantially simultaneously.

### CROSS REFERENCES TO RELATED APPLICATIONS

This application is a continuation-in-part of U.S. patent application Ser. No. 12/265,591 filed Nov. 5, 2008, which is a continuation-in-part of U.S. patent application Ser. No. 12/124,828 filed May 21, 2008, now abandoned, which claimed priority from European Patent Application 07015217.8 filed Aug. 2, 2007, which are hereby incorporated by reference as if fully set forth herein.

### STATEMENT REGARDING FEDERALLY SPONSORED RESEARCH

Not applicable.

### BACKGROUND OF THE INVENTION

The invention is directed to gas turbine engines that are a particular form of a combustion engine comprising mainly a compressor, a combustion chamber, and a turbine installed one after the other in the direction of the air and gas flow. In general, the turbine withdraws from the hot stream of gases coming out of the combustion chamber the energy needed to drive the compressor by means of a shaft. By this operation the pressure of the gas stream is approximately reduced by the amount corresponding to the energy withdrawn from the turbine for the compressor.

The two main applications of gas turbine engines are: (1) A gas turbine engine in which the hot gas stream transmits its total energy to one or more turbine groups. With a part of the energy the turbine serves the compressor. The rest of the energy drives, generally by means of a shaft, an external device such as a generator of electricity, the propeller of an aircraft or big ship, the rotor of a helicopter, a hovercraft, heavy vehicles or locomotives, and other devices (e.g., pumps). By this application the gas turbine engines are commonly called as gas turbines. The designation “gas turbine” will be used in the following for this application of gas turbine engines. (2) A gas turbine engine in which the remaining gases, after serving the first group of the turbine, stream out of the engine for the propulsion of an aircraft. In this application the gas turbine engine is commonly called a jet engine or an aero turbo engine. The designation “aero turbo engine” will be used in the following for this kind of gas turbine engine.

Since the creation of the modern gas turbine engines about fifty-five years ago, the main principle of the operation remained the same. It goes without saying that several improvements took place on these conventional gas turbine engines. Except for the improvements of a better profile and better material of the blade wheels, and a better technology for cooling, none of those improvements however brought a basic modification in the construction of gas turbine engines that could update the actual technology to a new generation of gas turbine engines.

The main principle of the operation remaining unchanged, is that about 70% of the produced energy in the combustion chamber is used for the performance of the compressor and only about 30% of the total energy is the useful effective energy that enables the aircraft to fly.

The turbines and compressors of gas turbine engines today, at the actual technical level, have at least the following disadvantages: (i) For the construction of a gas turbine engine with an acceptable output of air mass flow per second from the compressor, the blade wheels of the compressor must have a big size and a great number of blade wheels must be used. (ii) Conventional compressors have big dimensions and more weight. (iii) For the construction of a gas turbine engine with an acceptable withdrawal of energy from the hot gases, the turbine blade wheels must have a big size and a great number of turbine blade wheels must be used. (iv) Conventional turbines have big dimensions and more weight. (v) For the numerous blade wheels needed for the turbine and compressor sections, the gas turbine unit of the conventional gas turbine engine is too big and too heavy. (vi) The actual compressors of modern gas turbine engines, incorporating technology being approximately fifty-five years old, consume a large quantity of energy for a targeted output of air mass flow per second (in the following referred to as air mass flow/s). The large quantity of energy consumed from the compressor (approximately two-thirds of the total energy) results in a significant amount of more fuel consumption and less effective thrust for the flight.

Since fuel is a combustible resource, which is becoming rarer in this world, the fuel prices are getting higher and the fuel consumption is playing a bigger economical role in the choice of gas turbine engines.

The dimensions and especially the weights of conventional gas turbine engines, particularly aero turbo engines, have arrived a limit that does not allow any significant amelioration for better performance without raising the weight of an engine. An installation of heavier engines brings problems especially for the design and construction of aircrafts.

The importance of less weight and less fuel consumption for gas turbine engines has created the necessity to find a solution allowing the compressor to produce a higher performance of air mass flow/s by consuming less energy that is withdrawn from the turbine for the compressor.

### SUMMARY OF THE INVENTION

In one aspect, the invention may provide a gas turbine engine having less weight and less fuel consumption compared to conventional gas turbine engines.

In another aspect, the invention may provide a second of two compressor groups, located downstream of the first compressor group, having blade wheels rotating in a second compressor direction opposite to the first compressor direction such that a deviation of the performance defined as air mass flow/s between both compressor groups is minimized, and a detachment of the air mass flow from the blades of the first blade wheel of the second compressor group is substantially eliminated.

In another aspect, in order to avoid the air stream arriving from the first compressor group to be torn off from the blade wheels of the second compressor group, the invention may provide a bypass, which is provided between the inner wall of the compressor and the blade wheels of the second group of the compressor, starting at the upstream end and ending at the last blade wheel of the second group, which enables the air mass flow coming form the first group of the compressor to serve all the blade wheels of the second compressor group substantially simultaneously.

In accordance with another aspect of the invention, a targeted performance of a gas turbine engine may be realized by approximately two-thirds of the weight of a modern gas turbine engine, as outlined in the following in more detail. This characteristic of the weight is highly appreciated by the producers of aero turbo engines and producers of aircrafts.

The total performance of a gas turbine engine is proportional to the air mass flow/s produced by the compressor. Another aspect of the invention may allow the compressor to produce approximately at least 2.4 times more air mass flow than a conventional compressor by the same amount of energy withdrawn from the turbine, with the result of approximately 54% less fuel consumption and approximately 54% less gas emission for a targeted thrust of a gas turbine engine (e.g., see comparison No. 11 below).

In the following, explanations of the possible effects attained by aspects of the invention are described, including the basic modifications and the operational technology of the compressor. Additionally, the cooperative function between the compressor and the rest of the components of the example aero turbo engine are described.

### Actual Technical Standard

The very high rotational speeds of the blade wheels in compressors and pumps create an air mass flow that is almost circular, having a very low effective axial pressure. A guide wheel or guide plate is preferably installed next to every blade wheel to attempt to at least partially straighten the almost circular air mass flow. By this procedure, the air mass flow slows down and the axial pressure of the air mass flow increases to a useful magnitude.

Every combination of a blade wheel followed by a guide wheel or guide plate forms a set. As a result, every time a “blade wheel” is mentioned herein, it concerns a blade wheel plus a guide wheel or guide plate.

The efficiency of a compressor is a function of the axial pressure. The axial pressure of a single blade wheel without a guide wheel is too weak for a reasonable compressor efficiency because most of the energy of the air mass flow created by the blade wheel will be consumed for the production of the circular streaming of the air mass flow and not for the creation of an axial flow.

Chart No. 100 (shown in FIG. 7A) shows a vector diagram of two air streams. The vector AC represents the air mass flow of a single blade wheel and the vector AC1 represents the air mass flow of the same blade wheel in combination with a guide wheel.

Chart No. 1 (shown in FIG. 7B) shows a vector diagram of two air streams AC and BC2 produced by two identical blade wheels rotating in one and the same direction. The vectors AC and BC2 show the air mass flow after passing through the guide wheels installed each next to the corresponding blade wheel. The sum of these two vectors is AC+BC2=AC1. From the sum of the total energy transmitted to both blade wheels—vector AC1—only the vector AB1 is effective. The radial vector B1C1 represents the vector producing the twisting movement of the air mass flow that causes the turbulences in the air mass flow without any participation in the effective axial air mass flow. The disadvantages of two blade wheels rotating in one direction by the same rotational speed include (a) loss of energy through an undesirable twisting of the air mass flow and (b) presence of undesirable turbulences in the air mass flow.

From the original energy transmitted from the compressor to the air mass flow, represented by the vectors AC and BC2, only the axial vectors AB and BB1 are effective and can be effectual.

Chart No. 2 (shown in FIG. 7C) shows the vectors of two equal helicoidal air streams AC and AC1 for two identical blade wheels rotating in opposite directions to each other in accordance with an aspect of the invention. The vectors AC and AC1 show the air mass flow after they have passed through the guide wheels installed each next to the corresponding blade wheels. The components of the helicoidal vectors are:

AC=AB+BC

AC1=AB+BC1

The radial components BC and BC1, being equal and in opposite directions to each other, eliminate each other by straightening the full length of the helicoidal vectors AC and AC1. By the absence of the radial components there will be essentially no loss of energy due to undesirable rotational movements in the air mass flow, and the resulting air mass flow will be substantially totally axial and free from turbulences.

The concept of two similar blade wheels rotating in opposite directions to each other turns many of the disadvantages caused by the helicoidal air flow resulting from the rotational movement of two blade wheels in one direction to at least the following advantageous results: (i) The air mass flow streaming out of the compressor section is substantially totally axial without any substantial turbulence. (ii) The straightened vectors AC and AC1 are equal each to the axial vector AB2. For two blade wheels rotating in opposite directions to each other, the total effective axial vector is twice the vector AB2 equaling the vector AB3 (instead equaling the vector AB1). (iii) The vector AB3 is approximately 2.4 times more (+140%) than the vector AB1 that is the sum of the effective axial vectors AB+BB1 of two identical blade wheels rotating in one direction.

Different efficiencies may be obtained by different angles between the helicoidal air mass flow and the axle of the blade wheels as outlined in the following.

In Chart No. 3 (shown in FIG. 7D) three helicoidal vectors AA1, AX, and AB represent three different main vectors of air mass flow in the compressor. The angles between the helicoidal vectors of the air mass flow and the axial vector are chosen differently. By higher angles, the length of the main helicoidal vector is longer referring to the same effective axial flow.

The axial vector AC is the useful effective vector for all three vectors AB, AX, and AA1, which represent the energy transmitted from the compressor to the air mass flow.

Chart No. 3 (again, as shown in FIG. 7D) shows that by higher angles of the helicoidal vectors, the energy given to the air mass flow for a certain effective or useful axial flow is higher than the energy given to the air mass flow by a lower angle of the helicoidal vector. This phenomenon illustrates that the concept of the present invention is even more effective at higher angles of the helicoidal vectors because the full length of the helicoidal vector, which is longer by higher angles, will be straightened to a useful and effective axial vector.

In accordance with an aspect of the invention, all three vectors can be straightened in their full lengths. A straightened vector AA1 will turn to an axial vector AC1 with a length of 2.0 times the original axial vector AC, a straightened vector AX will turn to an axial vector AY that is 2.4 times the original axial vector AC, and a straightened vector AB will turn to an axial vector AC2 that is 2.75 times the original axial vector AC.

Chart No. 3 shows that higher angles between the helicoidal vector of an air mass flow and the axle of the compressor realize higher performances of the compressor by two blade wheels rotating in opposite directions to each other. On the other hand, very high angles realize uninteresting and not acceptable performances referring to the operational pressures. The designer of a gas turbine engine will have to plan the most efficient operating angle between the main vector of the helicoidal air mass flow and the axle of the compressor for the final construction of a gas turbine engine.

### Tendency of Detachment of the Air Mass Flow

What is valid for only two blade wheels rotating in opposite directions to each other is not entirely valid and applicable for two groups of several blade wheels rotating in opposite directions to each other.

By a compressor comprising two groups of four substantially identical blade wheels each, all the blade wheels of both groups being substantially identical, the air mass flow and the pressure produced by the first group is four times higher than the air mass flow and the pressure produced by only one blade wheel. The total air mass flow of the first group of the compressor leaves the first group of the compressor to encounter the second group of the compressor by its first blade wheel rotating in an opposite direction.

The first blade wheel of the second group of the compressor produces a helicoidal air mass flow and a pressure of only one blade wheel in an opposite direction. It does not have enough energy to face and withstand a helicoidal air mass flow that is four times stronger, nor to eliminate a part of the radial component. The air mass flow coming from the first group of the compressor overruns the air mass flow of the first blade wheel of the second group by detaching the air mass from its blades.

Chart No. 4 (shown in FIG. 7E) shows the vector AA4 that is the sum of the four vectors of the four blade wheels of the first group of the compressor. The radial component of the vector AA4 is the vector EA4.

The vector of the air mass flow of the first blade wheel of the second group of the compressor is represented by the vector EE1. The radial component of the vector EE1 is the vector EEO.

The radial vector EA4 being four times stronger and in an opposite direction to the vector EEO overruns the radial vector EEO by detaching the air mass flow of the vector EE1 from the blades of the first blade wheel in the second group of the compressor.

### Summary of the Technique Used by an Aspect of the Invention

Having given the above explanation, an example novel technique used by the invention may be summarized as follows: (a) Applying the theory of two similar blade wheels rotating in opposite directions to each other for two groups of blade wheels in the compressor section. (b) Designing approximately equal performances for both groups of the blade wheels of the compressor, and calculating the sum of the performances of all the blade wheels in each group. [Air mass flow=(diameter of the blade wheels)³] Small deviations between both groups of the compressor can be compensated through adjustments of the angles of the blades of the blade wheels. (c) Substantially eliminating the problem of the detachment by allowing the first group of the compressor to substantially serve all the blade wheels of the second group of the compressor substantially simultaneously. For this purpose, the first blade wheel of the second group of the compressor has a smaller diameter and the next two blade wheels have progressively increased diameter (as generally shown in FIGS. 2-4). The progressively increased diameters create a bypass between the blade wheels and the inner wall of the compressor that allows the air mass flow coming from the first group of the compressor to serve substantially all the blade wheels of the second groups of the compressor substantially simultaneously. The bypass may be more effective if the body of the compressor is slightly conical at the height of the second group of the compressor 135 as shown in FIG. 4A. A decision of the necessity of using smaller blade wheels in the beginning of the second group of the compressor by progressively increased diameter depends from the designed total number of blade wheels.

Chart No. 5 (shown in FIG. 7F) shows the sum of four vectors of the first group of the compressor AA4 with its radial component EA4. The sum of the radial vectors of the five blade wheels of the second group of the compressor (below the axial line AA'4) is EE5. The radial vectors EA4 and EE5 being equal and in opposite direction to each other substantially eliminate each other.

### Operational Description

The quantity of the air mass flow streaming through the bypass to each of the different blade wheels of the second compressor group (e.g., see FIGS. 2-4) will be regulated automatically through the performances calculated for each of the blade wheels. By the same rotational speed, every blade wheel has a certain capacity to compress a certain amount of air mass flow. It cannot compress more and if there is not enough air mass to compress it creates a vacuum in front of the blade wheel. The vacuum will attract and swallow the air mass which is present next to it.

The property of the blade wheels to be able to compress only a certain calculated air mass flow, but create a vacuum when a certain air mass flow is not present to be compressed, gives the possibility to all the blade wheels of the second compressor group to serve themselves with the air mass flow coming from the first compressor group substantially simultaneously.

In this manner, the radial component of the helicoidal air mass flow produced in the first compressor group will be substantially completely eliminated through the partial radial components of the blade wheels of the second compressor group (e.g., see chart No. 5 as shown in FIG. 7F). An aspect of the present invention is achieved thereby.

### A New Generation of Aero Turbo Engines and Gas Turbines

The fact that two identical blade wheels rotating in opposite directions to each other produce a significant amount of more air mass flow than two blade wheels rotating in the same direction belongs to an actual technical standard. This feature of two blade wheels rotating in opposite directions to each other could not be applied until now, for technical reasons, to two groups of blade wheels rotating in opposite directions to each other.

A new concept of technology has been developed that allows two groups of blade wheels to rotate in opposite directions to each other by producing an average of approximately 2.4 times more air mass flow than a conventional compressor by the same number of blade wheels rotating in one direction.

The creation of approximately 2.4 times more air mass flow by the same number of blade wheels is realized by substantially the same withdrawal of energy from the turbine. This characteristic of the new concept allows a compressor to consume approximately 2.4 times less energy than a conventional compressor for a determined targeted performance of air mass flow.

### Increase of the Efficiency

Assuming that a withdrawal of energy from the turbine for a conventional compressor is approximately two-thirds (i.e., 67%) of the total energy produced in the combustion chamber, the effective thrust will be approximately 33% (i.e., 100−67).

The withdrawal of energy from the turbine for a compressor according to the new concept is approximately (2/3)·(1/(2.4))=(1/(3.6))=28% of the total energy produced in the combustion chamber.

The remaining effective thrust will be approximately 72% (i.e., 100−28).

The approximate increase of the efficiency of an aero engine according to the new concept is (72−33)×(100/72)=54%.

### Reduction of Fuel Consumption

A reduction of fuel consumption of an aero turbo engine according to the new concept is substantially proportional to the increase of its efficiency compared to the efficiency of a conventional aero turbo engine, and is substantially independent from the number of blade wheels or effective thrust of an aero turbo engine. Depending on the increase of the efficiency of an aero turbo engine according to the new concept and to the “Comparison of Technical Data No. 11 and No. 12,” the reduction of fuel consumption of an engine according to the new concept is approximately 54%.

For an equal effective thrust of about 300 KN, the “Comparison of Technical Data No. 11” shows that (i) a conventional aero turbo engine (a) consumes 900 units of fuel, the number 900 being the total air mass flow entering the combustion chamber and being directly proportional to the fuel consumption, (ii) an aero turbo engine (b) according to the new concept consumes 415 units of fuel, and (iii) the reduction of fuel consumption between engines (a) and (b) is approximately (900−415)×(100/900)=54%.

The “Comparison of Technical Data No. 12” shows by pos. (a) the technical data of the same conventional engine as described under pos. (a) of the “Comparison of Technical Data No. 11.” It shows further under pos. (b) an aero turbo engine using only half the blade wheels of the compressor of the engine (a).

The “Comparison of Technical Data No. 12” shows further that even by using half the number of blade wheels in the compressor, an effective thrust is approximately 780/300=2.6 times more, and generally irrespective of the number of blade wheels of the compressor that are used and the effective thrust produced, aero turbo engines according to the new concept have approximately the same fuel consumption per 100 KN, which results with a reduction of fuel consumption of about 54% compared to the fuel consumption of conventional aero turbo engines.

A reduction of fuel consumption of 54% realizes a significant low cost for the airlines by additionally 54% less emission of undesirable gases in the atmosphere with the result of a slow down of the warming of the world climate.

Generally, 54% less fuel consumption allows 54% less fuel to carry by every flight that gives the possibility for an aircraft to increase the loading capacity for more passengers and freight. An aero turbo engine according to the new concept gives an aircraft flying from Frankfurt/Germany to Los Angeles/USA the possibility to carry an average of 75.000 liters less fuel in the tanks.

### Reduction of Weight of an Aero Turbo Engine

The explanations of the Chart Nos. 2 and 5 (i.e., FIGS. 7C and 7F, respectively) demonstrate that a compressor according to the new concept produces an average of 2.4 times more air mass flow than a conventional compressor. Accordingly, a compressor of an aero turbo engine according to the new concept needs only approximately 42% (i.e., 1/(2.4)) of the number of blade wheels of a conventional compressor, and logically of a conventional turbine, for an equal performance.

By taking the example of an aero turbo engine having 14 blade wheels in the compressor section, an equal performance of the compressor could be realized by approximately 14×42/100=6 blade wheels with a compressor according to an aspect of the new concept.

The fact of using only about 42% of the number of blade wheels in an aero turbo engine according to the new concept results in an approximate one-third less weight of the aero turbo engine.

### Comparison of Technical Data No. 11

Data of a conventional aero turbo engine (a) by a withdrawal of approximately two-thirds of the energy from the turbine for the compressor:

| | |
|---|---|
| Total thrust leaving the combustion chamber: | 900 KN |
| Energy withdrawal from the turbine for the compressor: | 600 KN |
| Effective thrust: | 300 KN |
| Approximate fuel consumption per 100 KN: 900 × 100/300: | 300 units |

Data of an aero turbo engine (b) according to an aspect of the present invention with an effective thrust of approximately 300 KN by a withdrawal of approximately 1/(3.6) of the total energy from the turbine for the compressor:

| | |
|---|---|
| Total thrust leaving the combustion chamber: | 415 KN |
| Energy withdrawal from the turbine for the compressor: | 115 KN |
| Effective thrust: | 300 KN |
| Approximate fuel consumption per 100 KN: 415 × 100/300: | 138 units |

The approximate reduction of fuel consumption between engines (a) and (b) is 54% (i.e., (300−138)×(100/300)).

In general, a method of calculation of the total thrust produced in the combustion chamber for an effective thrust of 300 KN of an aero turbo engine according to an aspect of the new concept is:

X=total thrust

X−(2/3·(1/(2.4))·X)=300

X−((1/(3.6))X)=300

(2.6/3.6)X=300

X=300·(3.6/2.6)=415KN

### Comparison of Technical Data No. 12

Data of conventional aero turbo engine (a) by a withdrawal of approximately two-thirds of the energy from the turbine for the compressor:

| | |
|---|---|
| Total thrust leaving the combustion chamber: | 900 KN |
| Energy withdrawal from the turbine for the compressor: | 600 KN |
| Effective thrust: | 300 KN |
| Approximate fuel consumption per 100 KN: 900 × 100/300: | 300 units |

Data of an aero turbo engine (b) according to the present invention by half the number of blade wheels of the compressor of the engine (a):

| | | |
|---|---|---|
| Total thrust leaving the combustion chamber: | 1080 | KN |
| Energy withdrawal from the turbine for the compressor: | 300 | KN |
| Effective thrust: | 780 | KN |
| Approximate fuel consumption per 100 KN: | 138 | units |
| 1080 × 100/780: | | |

The approximate reduction of fuel consumption between engines (a) and (b) is 54% (i.e., (300−138)·(100/300)).

### Aspects of the New Concept

In one aspect, a compressor according to the new concept produces an average of 2.4 times more air mass flow than a conventional compressor by the same number of blade wheels.

According to another aspect of the new concept, approximately 1/(2.4)=42% of the number of blade wheels of a conventional compressor are needed for an equal performance of air mass flow.

In another aspect, an aero turbo engine according to the new concept has approximately one-third less weight than a conventional aero turbo engine.

In a further aspect, a targeted thrust may be realized by approximately 54% less fuel consumption. Thus, 54% less fuel consumption results in a lower cost of fuel per passenger and loading unit, and allows approximately 54% less fuel to carry by every flight, which gives the possibility to increase the loading capacity for more passengers and freight. For instance, a long distance aircraft flying from Frankfurt to Los Angeles would carry 70.000 to 90.00 liters less fuel in the tanks.

The possibility to have a significant amount of more thrust by the same weight of an aero turbo engine, or have approximately one-third less weight of the engine for a targeted thrust, or have 54% less fuel to carry resulting from a lower fuel consumption, allow a designer the opportunity to develop a new aircraft that may address aircraft users demanding a significant improvement of the aircraft relating to the performance and to the economy.

The total fuel consumption of all the aircrafts in this world is enormous. By saving an average of 54% of the fuel consumption due to more economic aero turbo engines, the limited oil resources in this world will be for a significant period of time longer available than predicted. Moreover, 54% less fuel consumption realizes 54% less emission of undesirable gases in the atmosphere resulting with a slow down of the warming of the world climate.

In another aspect, a new design of an aero turbo engine according to the new concept can be developed by using most of the components of a conventional aero turbo engine, thus reducing the developing costs of a new design.

According to an aspect of the present invention, an air mass flow streaming into the combustion chamber without any turbulence realizes a better ignition and a homogeneous burning of the fuel with the result of less fuel consumption.

In accordance with yet a further aspect, the compressor produces a higher performance that overcomes more easily the static pressure, which in other words is the inner resistance of the gas turbine engine.

Contrary to an engine according to an aspect of the present invention, a rotation of all the blade wheels in one direction by a conventional engine causes a one-sided stress to all the moving components of the engine.

According to another aspect of the present invention, a steeper angle between the helicoidal air mass flow and the axle of the compressor allows even higher performances of the compressor.

In another aspect, with the help of a new designed bypass, the first compressor group serves all the blade wheels of the second compressor group substantially simultaneously to significantly eliminate the tendency of detachment of the air mass from the blades of the first blade wheel of the second compressor group.

In the accompanying drawings, preferred example embodiments of the present invention are described in detail. The drawings are not to be understood as limiting the scope of the invention. Moreover, further aspects of the invention will become apparent from the following description.

### BRIEF DESCRIPTION OF THE DRAWINGS

FIG. 1 is a simplified cross-section illustrating a conventional gas turbine engine comprising a compressor 1, a combustion chamber 2, a turbine 3, two shafts 4 and 5, and a guide wheel 10 installed next to every blade wheel.

FIG. 1A is a simplified cross-section illustrating a second application of a conventional gas turbine engine comprising a compressor 1, a combustion chamber 2, a turbine 3, an outlet 6 for the hot stream of gases, and a guide wheel 10 next to every blade wheel.

FIG. 2 is a simplified cross-section illustrating a first embodiment according to the present invention that shows an aero turbo engine comprising two groups of a compressor 131 and 135 rotating in opposite directions to each other with the help of a reverse mechanism 100 installed between both groups of the compressor 131 and 135, a combustion chamber 2, and a conventional turbine 3 with two blade wheels 151 and 152. A guide wheel 10 is installed next to every blade wheel. Three steel tubes 200 cover the three shorter blade wheels in the second group of the compressor 135.

FIG. 3 is a simplified cross-section illustrating a second embodiment according to the present invention that shows an aero turbo engine with two groups of a compressor 131 and 135, a combustion chamber 2, a turbine section 3 comprising a first blade wheel of the turbine 151 with shorter blades, an axial converter 190, and a second blade wheel of the turbine 152. The first blade wheel of the turbine 151 together with the axial converter is covered with a steel tube. Both blade wheels of the turbine 151 and 152 are connected to both groups of the compressor 131 and 135 by means of two concentric shafts 170. A guide wheel 10 is installed next to every blade wheel. Three steel tubes 200 cover the shorter blade wheels in the second group of the compressor 135.

FIG. 4 is a simplified cross-section illustrating a third embodiment according to the present invention that shows an aero turbo engine with two groups of a compressor 131 and 135, a combustion chamber 2, a turbine 3 comprising a first blade wheel 151 with shorter blades, an axial converter 190, and a second blade wheel 152 with slightly longer blades than the blades of the first blade wheel 151. All of the components of the turbine 3 comprising a first blade wheel 151, an axial converter 190, and a second blade wheel 152 are covered with a steel conical tube 160. Both blade wheels of the turbine 151 and 152 are connected to both groups of the compressor 131 and 135 by means of two concentric shafts 170. A guide wheel 10 is installed next to every blade wheel. Three rings 200 cover the shorter blade wheels in the second group of the compressor 135.

FIG. 4A is a simplified cross-section illustrating an example body of the compressor in accordance with an aspect of the invention by which the wall 136 of the compressor is conical at the height of the second group of the compressor 135, all blade wheels of this group having different diameters.

FIG. 4B is a simplified cross-section illustrating another example body of the compressor in accordance with an aspect of the invention by which the wall 136 of the compressor is conical at the height of the second group of the compressor 135, all blade wheels of this group having the same diameter.

FIG. 5A is a simplified front elevation view illustrating an example axial converter 190 to be installed between both groups of a turbine to straighten the helicoidal air mass flow coming out of the first group of the turbine.

FIG. 5B is a simplified side elevation view of the axial converter 190 shown in FIG. 5A.

FIG. 6 is an isometric view of an aspect of the invention illustrating two concentric shafts that connect both groups of the turbine to both groups of the compressor.

FIGS. 7A-7F include Chart Nos. 100, 1, 2, 3, 4, and 5, respectively, which illustrate the example vectorial components of the air mass flow in the compressor section of a gas turbine engine.

### DETAILED DESCRIPTION OF THE PREFERRED EXAMPLE EMBODIMENTS

In the accompanying drawings, preferred example embodiments of the present invention are described in detail. The drawings are not to be understood as limiting the present invention to only the illustrated and described examples as to how the invention can be used and presented. Further features and aspects will become apparent from the following and particular description of the invention, which is illustrated in the accompanying drawings wherein similar elements and structures are designed by the same numerals.

For the realization of the new concept, it's preferred that two groups of blade wheels in the compressor be driven in opposite directions to each other by approximately an equal performance of air mass flow.

Nearly every major producer of aero turbo engines has its own methods of inversing a rotational movement. By the description of the drawings, some methods of inversion of the rotational movement of the turbine and of the compressor are proposed. However, one of ordinary skill in the art will appreciate the variety of methods and techniques of inversion capable of use with this disclosure.

In all the drawings, the number of blade wheels are chosen for illustrative purposes. Any other number of blade wheels may be used from the designer as long as both groups of the compressor rotate in opposite directions to each other by approximately an equal performance of air mass flow.

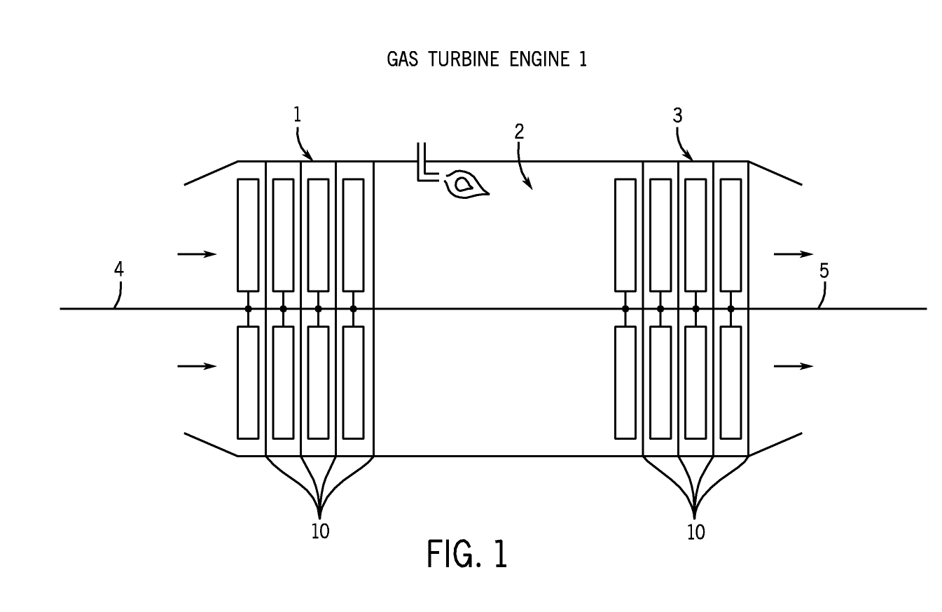

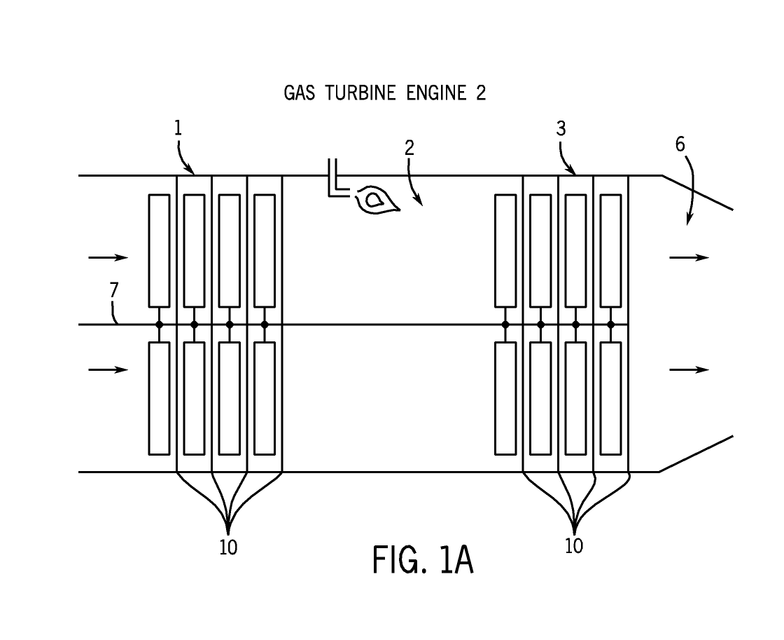

With initial reference to FIG. 1, FIG. 1 shows the principle of a conventional gas turbine that consists mainly of a compressor 1, a combustion chamber 2, a turbine 3, and a shaft 4, 5. The turbine 3 withdraws substantially all of the energy from the hot gases streaming out of the combustion chamber 2. A part of this energy serves to drive the compressor 1. The rest of the energy may be transmitted to an external device by means of the shaft 4, 5. A guide wheel 10 is installed next to every blade wheel to substantially eliminate an almost circular air and gas streaming.

Turning to FIG. 1A, FIG. 1A shows an application of a simplified conventional gas turbine engine, which is an aero turbo engine, comprising mainly a compressor 1, a combustion chamber 2, a turbine 3, and an outlet 6. The turbine 3 withdraws from the hot gases streaming out of the combustion chamber 2 the energy required to drive the compressor 1 by means of a shaft 7. The rest of the hot gases streams out of the outlet 4 for the propulsion of an aircraft and the like. A guide wheel 10 is installed next to every blade wheel to substantially eliminate an almost circular air and gas streaming.

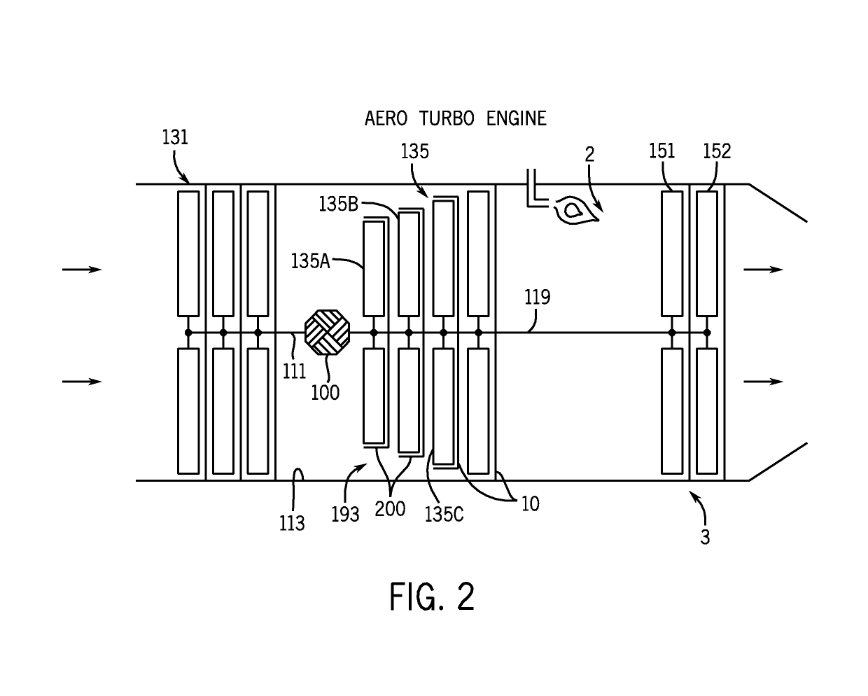

With specific reference to FIG. 2, FIG. 2 shows a first embodiment according to the present invention that allows both groups of the compressor 131, 135 to rotate in opposite directions to each other with the help of a reverse mechanism 100. A shaft 119 connects the turbine 3 to the second group of the compressor 135 and to the reverse mechanism 100. A second shaft 111 connects the other side of the reverse mechanism 100 to the first group of the compressor 131. The turbine 3 withdraws from the hot gases streaming out of the combustion chamber 2 the energy required so that both groups of the compressor 131, 135 rotate in opposite directions to each other by approximately an equal performance.

The performance of each group of the compressor 131, 135 can be calculated roughly by adding the partial performances of each of the blade wheels in each group. The partial performance of a blade wheel can be calculated with the following formula:

Air mass flow=(diameter of the blade wheel)³

For example, in FIG. 2, three blade wheels of the first group of compressor 131 have each a diameter of approximately 7.5 units. The performance of the first group of the compressor is: 3·(7.5)³=1,266 units. (The influence of the pressure is not considered in the calculations of this example.)

The performance of the second group of the compressor is approximately:

1·(6.0)³=216

1·(6.6)³=287

1·(7.0)³=343

1·(7.5)³=422
Total performance: 1,268 units

The difference of performances between the first group 131 and the second group 135 of the compressor may be compensated through adjustments of the angles of the blades of all the blade wheels in the compressor section.

The first blade wheel 135A of the second group 135 of the compressor is designed by a smaller size and the next two blade wheels 135B, 135C by progressively increased diameters, thus creating a bypass 193 between the blade wheels of the second group of the compressor 135 and the inner wall 113 of the compressor. This bypass 193 allows the air mass flow coming from the first group of the compressor 131 to serve all the blade wheels of the second group of the compressor 135 substantially simultaneously, thus largely eliminating the possibility of a detachment of the air mass flow from the blades of the first blade wheel 135A of the second group of the compressor 135.

Three steel tubes 200 cover the shorter designed blade wheels 135A, 135B, 135C of the second group of the compressor 135 to allow higher performances and a better distribution of the air mass among the blade wheels 135A, 135B, 135C of the second group of the compressor 135. A guide wheel 10 is installed next to every blade wheel to eliminate an almost circular air and gas streaming.

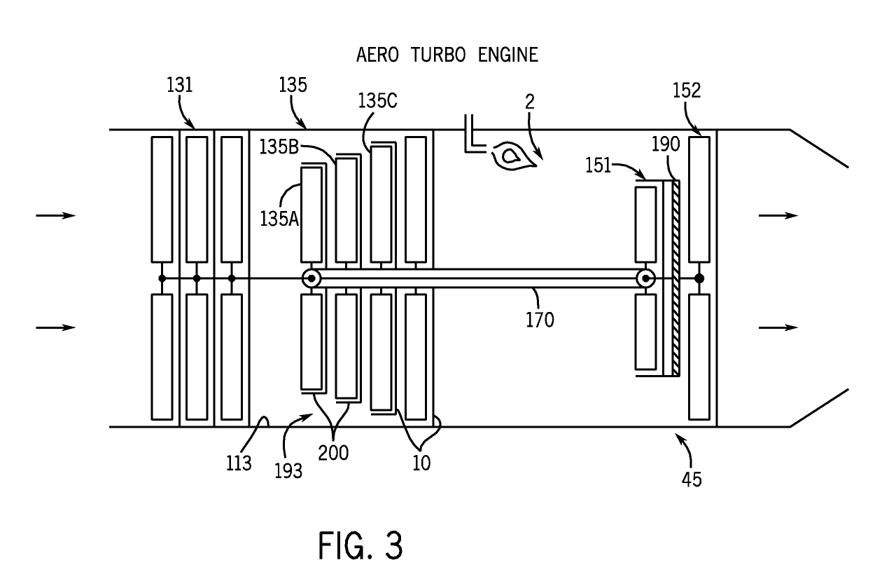

Turning to FIG. 3, a second embodiment according to the present invention that allows both groups of the compressor to rotate in opposite directions to each other with the help of two concentric shafts 170 is shown.

The turbine section 45 consists of a first blade wheel of the turbine 151 with shorter blade wheels because of the fact that the first blade wheel of the turbine withdraws only about 14% from the hot gases streaming out of the combustion chamber 2, an axial converter 190, and a second blade wheel of the turbine 152 installed one after the other in the direction of the gas flow. The gas flow streaming out of the combustion chamber 2 makes the first blade wheel of the turbine 151 rotate in one direction. A helicoidal gas flow streams out of the first blade wheel of the turbine 151 into an axial converter 190 that substantially straightens the helicoidal gas flow coming out of the first blade wheel of the turbine 151. Only a general axial flow of a gas can make the second blade wheel of the turbine 152 rotate in an opposite direction to the first blade wheel of the turbine 151.

The two concentric shafts 170 connect the first blade wheel of the turbine 151 to the second group of the compressor 135 and the second blade wheel of the turbine 152 to the first group of the compressor 131. Both blade wheels of the turbine 151, 152 withdraw from the hot stream of gases the energy required for both groups of the compressor 131, 135 to rotate in opposite directions to each other by approximately an equal performance of air mass flow.

The performance of each group of the compressor 131, 135 can be approximately calculated by adding the partial performances of the blade wheels in each group. The partial performance of the blade wheels can be calculated with the following formula:

Air mass flow=(diameter of the blade wheel)³

For example, in FIG. 3 the first group of the compressor 1 comprises three blade wheels having each a diameter of 7.5 units. The performance of the first group of the compressor is 3·(7.5)³=1,266 units. (The influence of the pressure is not considered in the calculations of this example.)

The performance of the second group of the compressor 135 is:

1·(6.0)³=216

1·(6.6)³=287

1·(7.0)³=343

1·(7.5)³=422
Total performance: 1,268 units

The difference of performances between the first group 1 and the second group 2 of the compressor is approximately 1,268−1,266=2 units. These 2 units may be compensated through an adjustment of the angles of the blades of all the blade wheels in the compressor section.

The first blade wheel 135A of the second group of the compressor 135 is designed by a smaller size and the next two blade wheels 135B, 135C are designed by progressively increased diameters, thus creating a bypass 193 between the blade wheels of the second group 135A, 135B, 135C of the compressor 135 and the inner wall 113 of the compressor. This bypass 193 allows the air mass flow coming from the first group of the compressor 131 to serve all the blade wheels of the second group of the compressor 135 substantially simultaneously thus largely eliminating the possibility of a detachment of the air mass flow from the blades of the first blade wheel 135A of the second group of the compressor 135.

Three steel tubes 200 cover the shorter designed blade wheels 135A, 135B, 135C of the second group of the compressor 135 to allow higher performance and a better distribution of the air mass flow among the blade wheels of the second group of the compressor 135. A guide wheel 10 is installed next to every blade wheel to eliminate an almost circular air or gas streaming behind each blade wheel.

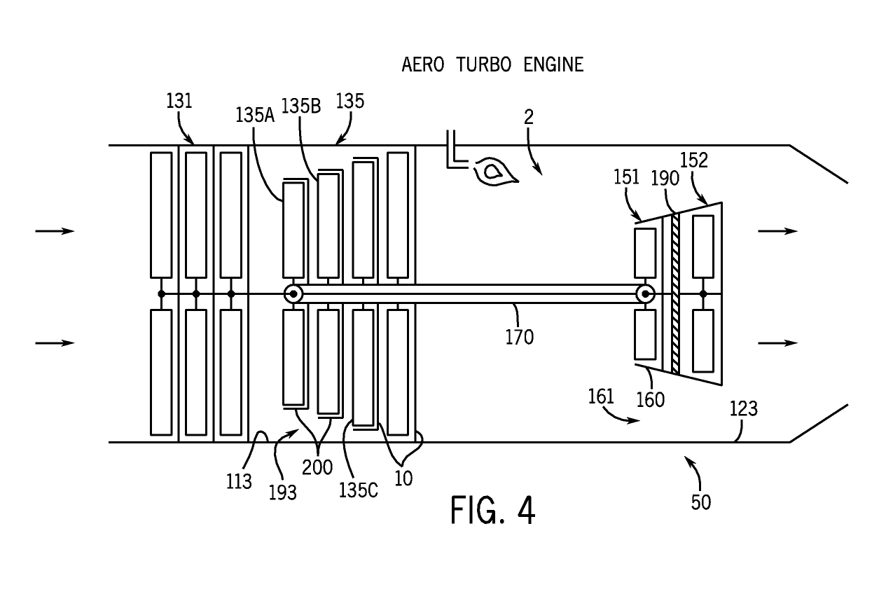

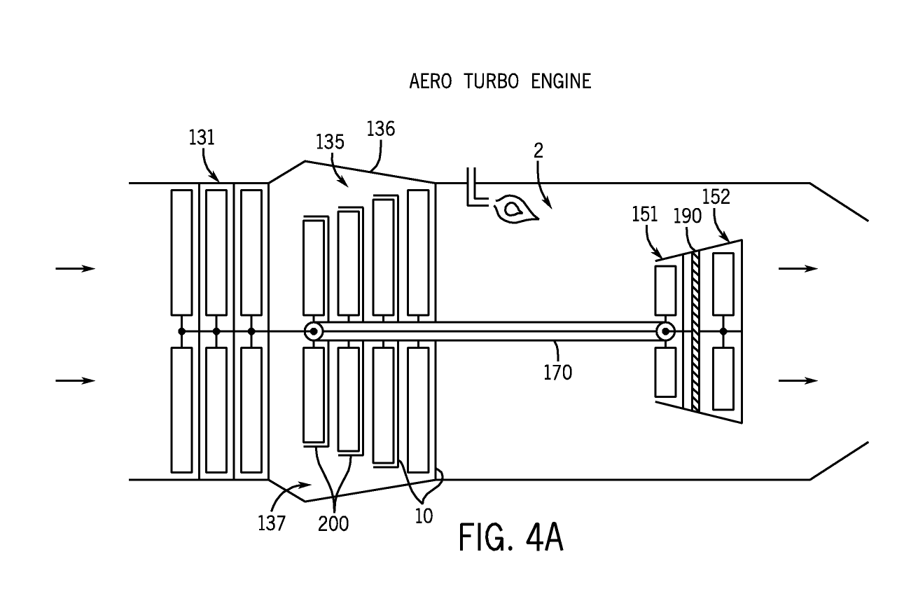

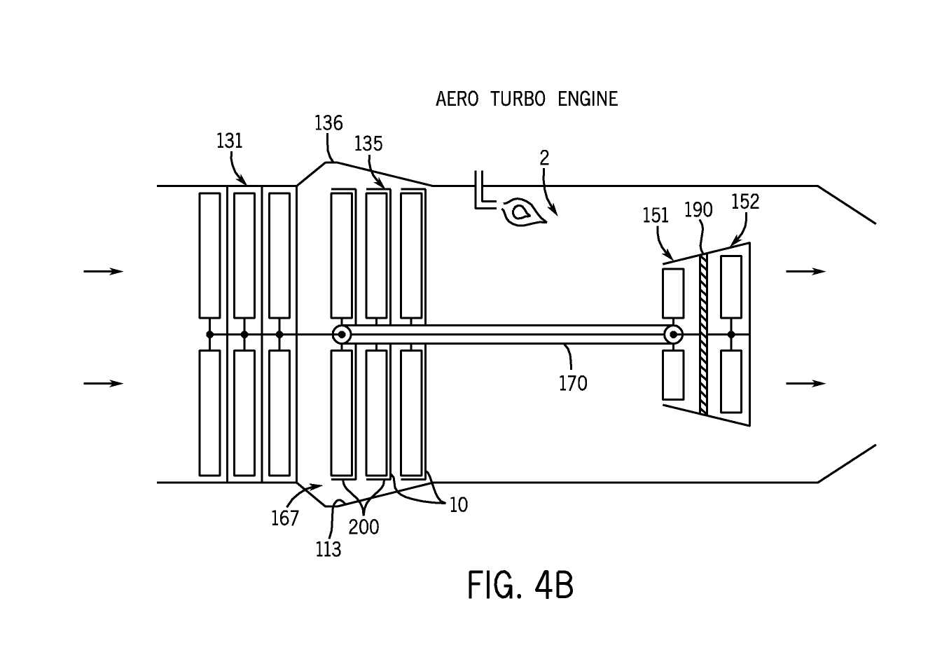

With specific reference to FIG. 4, FIG. 4 shows a third embodiment according to the present invention that allows both groups of the compressor 131, 135 to rotate in opposite directions to each other by means of two concentric shafts 170.

The turbine section 50 comprises a first blade wheel of the turbine 151, an axial converter 190, and a second blade wheel of the turbine 152 installed one after the other in the direction of the gas flow.

The blades of the first blade wheel of the turbine 151 are shortened because of the fact that the first bade wheel of the turbine 50 withdraws only about 14% from the hot gases streaming out of the combustion chamber 2. For the same reason, the blades of the second blade wheel of the turbine 152 are shortened, as they also withdraw about the same quantity of 14% from the hot gases. The blades of the second blade wheel 152 of the turbine are slightly longer than the blades of the first blade wheel of the turbine 151, because they are served with a weaker gas flow than the first blade wheel 151. The gas flow gets slightly weaker by passing through the axial converter.

The axial converter 190 substantially straightens the helicoidal gas flow coming from the first blade wheel of the turbine 151, then a generally axial flow can make the second blade wheel of the turbine 152 rotate in an opposite direction to the first blade wheel of the turbine 151.

All the components of the turbine 50, namely the first blade wheel 151, the axial converter 190, and the second blade wheel of the turbine 152 are covered by a conical steel tube 160 that allows a bypass 161 for the approximately 72% of the gas flow between the conical steel tube 160 and the inner wall 123 of the turbine 50.

The two concentric shafts 170 connect the first blade wheel of the turbine 151 to the second group of the compressor 135 and the second blade wheel of the turbine 152 to the first group of the compressor 131. Both blade wheels of the turbine 50 withdraw from the hot stream of gases the energy required so that both groups of the compressor 131, 135 rotate in opposite directions to each other by approximately an equal performance of air mass flow.

The performance of each group of the compressor 131, 135 can be approximately calculated by adding the partial performances of the blade wheels in each group. The partial performance of a blade wheel can be calculated with the following formula:

Air mass flow=(diameter of the blade wheel)³

For example, in FIG. 4 the first group of the compressor 131 comprises three blade wheels having each a diameter of 7.5 units. The performance of the first group of the compressor is: 3·(7.5)³=1,266 units. (The influence of the pressure is not considered in the calculations of this example.)

The performance of the second group of the compressor 135 is:

1·(6.0)³=216

1·(6.6)³=287

1·(7.0)³=343

1·(7.5)³=422
Total performance: 1,268 units

The difference of performances between the first group 131 and the second group 135 of the compressor is 1,268−1,266=2 units. These 2 units may be compensated through adjustments of the angles of the blades of all the blade wheels in the compressor.

The first blade wheel 135A of the second group of the compressor 135 is designed by a smaller size and the next two blade wheels 135B, 135C are designed by progressively increased diameters, thus creating a bypass 193 between the blade wheels of the second group of the compressor 135 and the inner wall 113 of the compressor. This bypass 193 allows the air mass flow coming from the first group of the compressor 131 to serve all the blade wheels of the second group of the compressor 135 substantially simultaneously thus largely eliminating the possibility of a detachment of the air mass flow from the blades of the first wheel blade 135A of the second group of the compressor 135.

Three steel tubes 200 cover the shorter designed blade wheels 135A, 135B, 135C of the second group of the compressor 135 to allow higher performance and a better distribution of the air mass flow among the blade wheels of the second group of the compressor 135. A guide wheel 10 is installed next to every blade wheel to eliminate an almost circular air or gas streaming behind each blade wheel.

As shown in FIG. 4A, an example designed body of the compressor by which the wall 136 of the compressor at the height of the second group of the compressor 135 is substantially conical. The conical part of the body of the compressor is for creating an effective bypass 137 when the blade wheels of the second group of the compressor 135 have progressively increased diameter, wherein these blade wheel contribute to the bypass 137 because of their increasing diameter.

Turning to FIG. 4B, the same body of the compressor as in FIG. 4A is shown having a conical part. In contrast to FIG. 4A, all blade wheels of the second group of the compressor have equal diameters. Also, this embodiment provides for an effective bypass 167 between the body and the blade wheels mainly due to the conical shape of the body of the compressor, the blade wheels themselves do not contributing to the bypass because of their equal diameters. The same conical part of the body of the compressor shows another method of creating a bypass 167 between the inner wall 113 and the blade wheels of the second group of the compressor 135 in the case that all the blade wheels have equal diameters.

Turning to FIGS. 5A and 5B, an example axial converter 190 to be used for the second embodiment (FIG. 3) and the third embodiment (FIG. 4) is shown. The width of the axial converter 190 may be adapted to the characteristics of the gas stream, such as the pressure and velocity, which is to be straightened. Generally, a gas stream having more pressure and more velocity requires an axial converter 190 with more width to substantially fully straighten the stream.

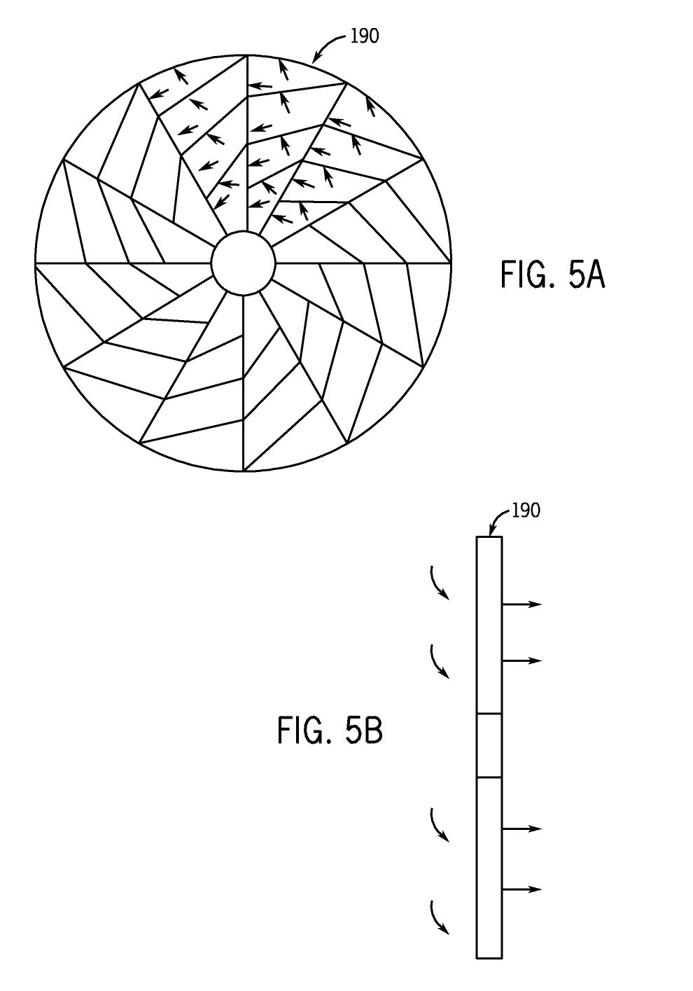

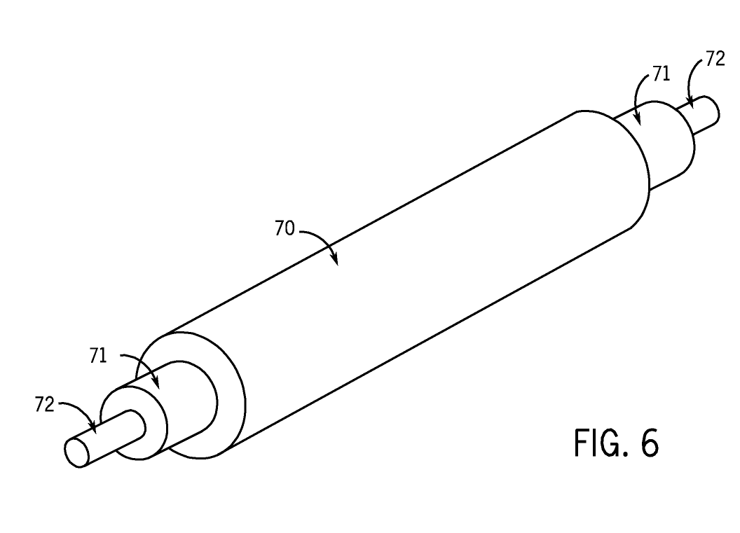

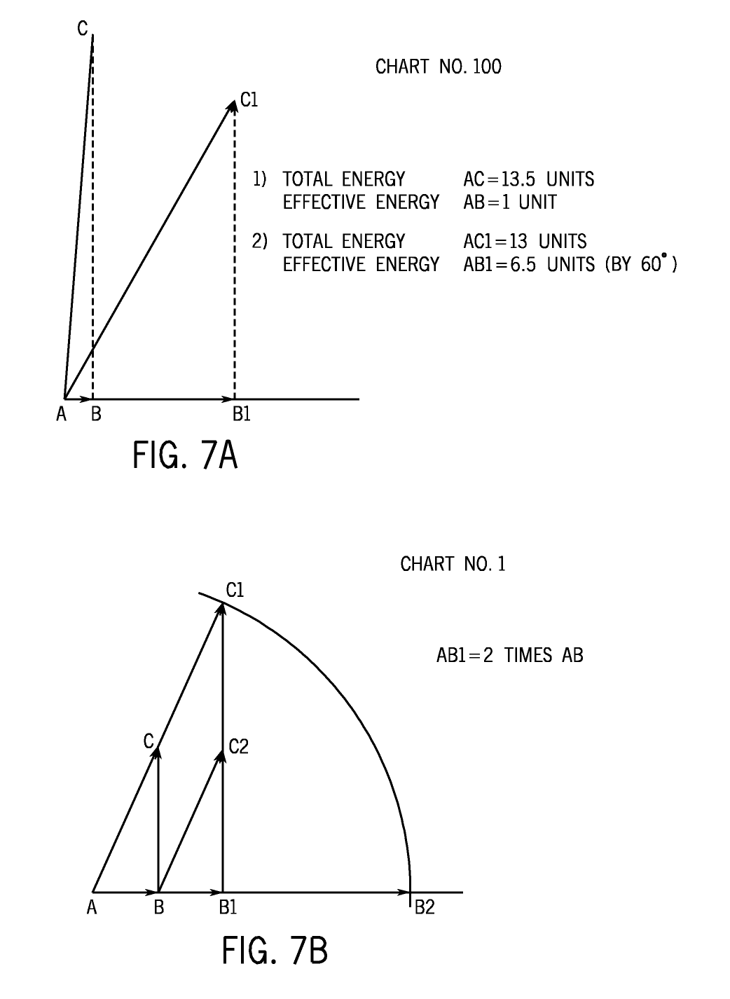

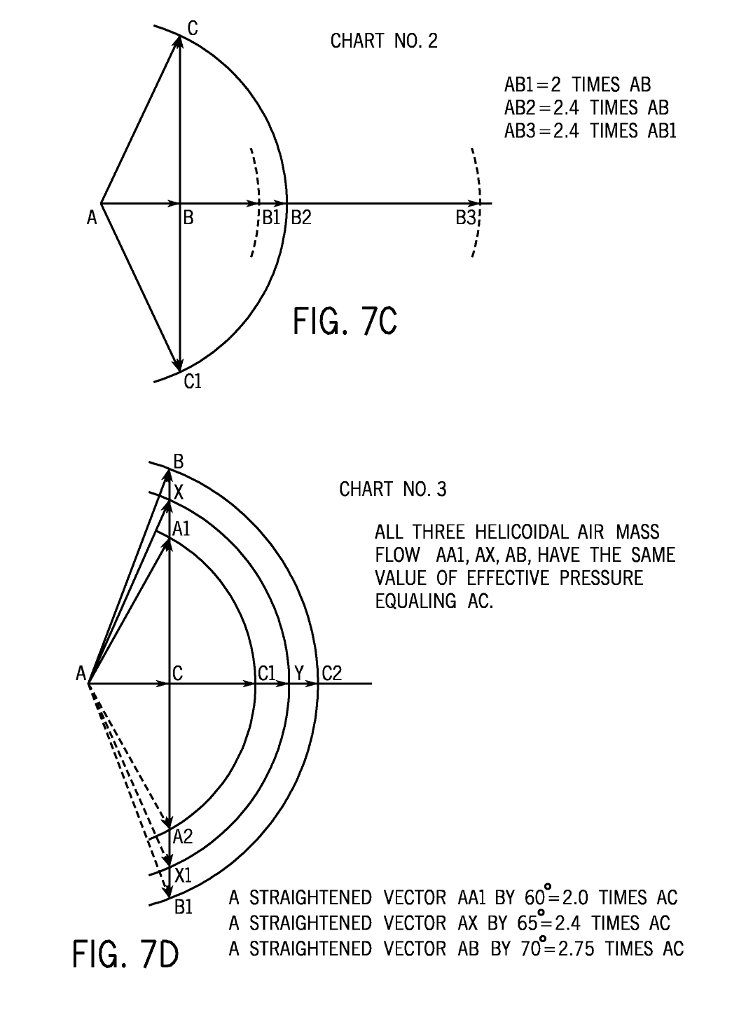

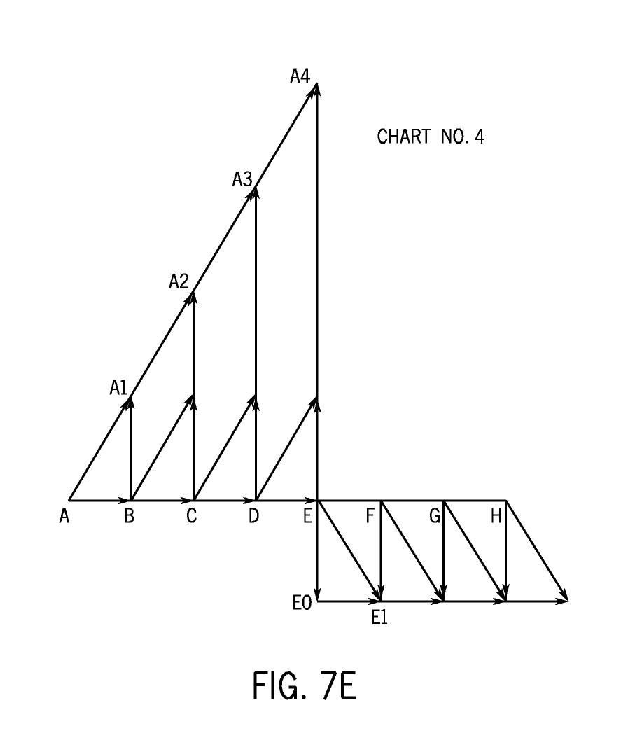

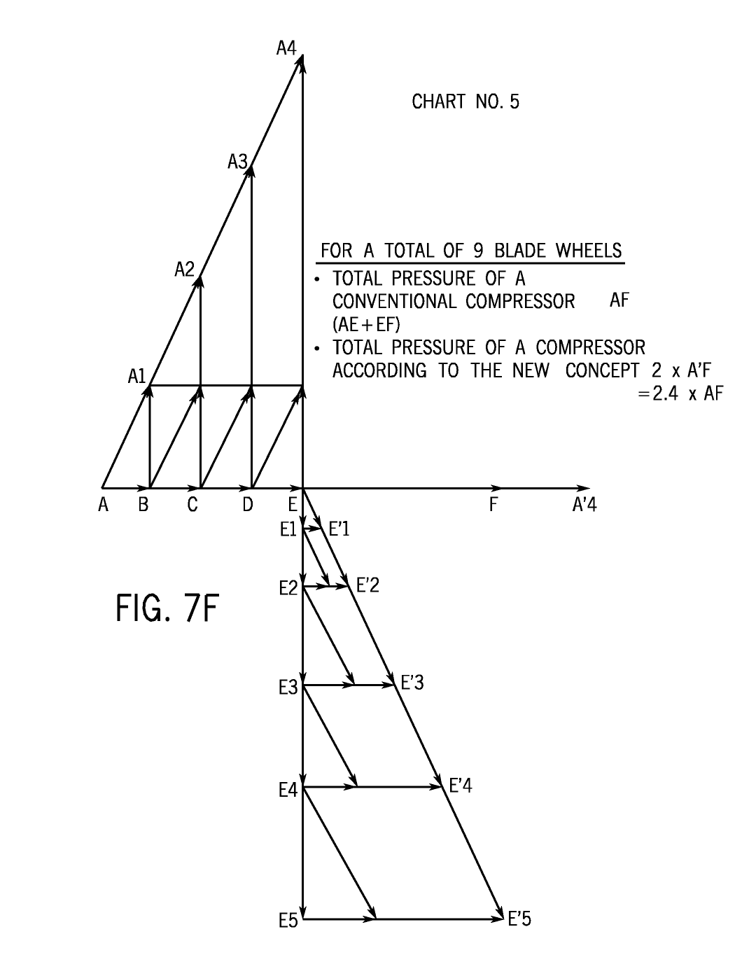

Two concentric shafts 72 and 71 are shown in FIG. 6 with their protective covering 70. Bearings installed between the shafts 72, 71 and their cover 70 secure the rotation of the shafts 72 and 71 in one or the other direction.

While the invention has been described with respect to preferred example embodiments, given the benefit of this disclosure, one of ordinary skill in the art will appreciate that various modifications, variations, and improvements may be made without departing from the intended scope of the invention. In addition, areas in which those of ordinary skill in the art are familiar have not been described, in order not to unnecessarily obscure the invention. Accordingly, it is to be understood that the scope of the claims is not limited by the specific illustrative embodiments.

We claim:

1. A gas turbine engine comprising:
a compressor;
a combustion chamber downstream of the compressor in a direction of an air mass flow; and
a turbine downstream of the combustion chamber in the direction of the air mass flow;
wherein the compressor comprises:
a first group of compressor blade wheels rotating in a first compressor direction; and
a second group of compressor blade wheels positioned downstream of the first group of compressor blade wheels and rotating in a second compressor direction that is opposite to the first compressor direction such that a deviation of a performance defined as air mass flow per second between the first group of compressor blade wheels and the second group of compressor blade wheels is minimized, and a detachment of the air mass flow from blades of a first blade wheel of the second group of compressor wheels is substantially eliminated; and
a bypass between an inner wall of the compressor and the second group of compressor blade wheels;
wherein the bypass extends substantially proximate the first blade wheel of the second group of compressor blade wheels to a last blade wheel of the second group of compressor blade wheels positioned downstream of the first blade wheel to enable the air mass flow flowing from the first group of the compressor blade wheels to substantially serve all of the second group of compressor blade wheels substantially simultaneously.

2. The gas turbine engine of claim 1, wherein the bypass is generally conical having a larger cross-section at an upstream end proximate the first blade wheel of the second group of compressor wheels.

3. The gas turbine engine of claim 2, wherein a conical widening of the inner wall of the compressor defines at least a portion of the bypass.

4. The gas turbine engine of claim 2, wherein diameters defined by each of the second group of compressor blade wheels are progressively larger downstream from the first blade wheel.

5. The gas turbine engine of claim 2, wherein diameters defined by each of the second group of compressor blade wheels are substantially similar.

6. The gas turbine engine of claim 1, wherein the performance the first group of compressor blade wheels is approximately equal to the performance of the second group of compressor blade wheels such that the air mass flow flowing from the first group of compressor blade wheels serves all of the second group of compressor blade wheels approximately simultaneously.

7. The gas turbine engine of claim 4, wherein:
the first group of compressor blade wheels define compressor diameters, each being substantially similar; and
the second group of compressor blade wheels comprise:
a first diameter defined by the first blade wheel approximately 80% of the compressor diameters;
a second diameter defined by a second blade wheel approximately 88% of the compressor diameters;
a third diameter defined by a third blade wheel approximately 93% of the compressor diameters; and
a last diameter defined by the last blade wheel approximately 100% of the compressor diameters.

8. The gas turbine engine of claim 4, wherein:
the second group of compressor blade wheels comprises one more blade wheel than the first group of compressor blade wheels; and
rings cover each of the second group of compressor blade wheels except for the last blade wheel to allow higher performance of the second group of compressor blades and a better distribution of the air mass flow between all of the second group of compressor blade wheels.

9. The gas turbine engine of claim 5, wherein:
the first group of compressor blade wheels and the second group of compressor blade wheels comprise an equal number of blade wheels; and
rings cover each of the second group of compressor blade wheels except for the last blade wheel to allow higher performance of the second group of compressor blade wheels and a better distribution of the air mass flow between all of the second group of compressor blade wheels.

10. The gas turbine engine of claim 1, further comprising:
adjustable first angles defined by the first group of compressor blade wheels; and
adjustable second angles defined by the second group of compressor blade wheels;
wherein the adjustable first angles and the adjustable second angles may be adjusted to operate the compressor at a high angle between a helicoidal air mass flow and an axle of the compressor to obtain a high performance of the compressor by straightening the helicoidal air mass flow to a substantially axial flow.

11. The gas turbine engine of claim 5, wherein:
rotating the first group of compressor blade wheels defines a first performance;
rotating the second group of compressor blade wheels defines a second performance;
wherein the first performance and the second performance are approximately equal to substantially reduce turbulences in the air mass flow.

12. The gas turbine engine of claim 1, further comprising:
a reverse mechanism coupled between the first group of compressor blade wheels and the second group of compressor blade wheels to inverses the first compressor direction relative to the second compressor direction; and
a shaft coupled to the turbine and the second group of compressor blade wheels.

13. The gas turbine engine of claim 1, wherein:
the turbine further comprises:
a first group of turbine blade wheels having at least a first turbine blade wheel rotating in a first turbine direction; and
a second group of turbine blade wheels having at least a second turbine blade wheel positioned downstream of the at least a first turbine blade wheel and rotating in a second turbine direction that is opposite to the first turbine direction;
a first shaft coupling the first group of compressor blade wheels and one of the first group of turbine blade wheels and the second group of turbine blade wheels; and
a second shaft that is concentric with the first shaft coupling the second group of compressor blade wheels with the other of the first group of turbine blade wheels and the second group of turbine blade wheels;
wherein the first shaft and the second shaft transmit energy from the turbine to the compressor.

14. The gas turbine engine of claim 13, further comprising an axial converter positioned downstream of the first group of turbine blade wheels and upstream of the second group of turbine blade wheels.

15. The gas turbine engine of claim 14, wherein the axial converter is configured to substantially straighten a helicoidal streaming of gases flowing from the first group of turbine blade wheels to serve the second group of turbine blade wheels.

16. The gas turbine engine of claim 15, wherein a first diameter of the first turbine blade wheel is less than a second diameter of the second turbine blade wheel such that the first group of turbine blade wheels withdraws less energy from a gas stream and is substantially equal to a withdrawal of energy from the gas stream by the second group of turbine blade wheels.

17. The gas turbine engine of claim 16, further comprising:
a tube covering the first group of turbine blade wheels; and
a bypass defined between the tube and an inner wall of the turbine.

18. The gas turbine of claim 17, wherein the tube is a conical tube covering the first group of turbine blade wheels, the axial converter, and the second group of turbine blade wheels.

19. The gas turbine engine of claim 1 further comprising:
a shaft operationally coupled to at least one of the compressor and turbine for driving an external rotating device;
wherein the shaft is configured to drive at least one of a pump, a rotor of a helicopter, a propeller of a turboprop aircraft, a water vehicle, a propeller of a hovercraft, an earth bound heavy vehicle, a tank, a pump for fuel or gas pipelines, and a generator for electricity production.

20. The gas turbine engine of claim 1, wherein the gas turbine engine is adapted to an aero turbo engine such that gases streaming out of the turbine provide propulsion of an aircraft.
